(19) United States
(12) Patent Application Publication
(10) Pub. No.: US 2003/0030878 A1
(43) Pub. Date: Feb. 13, 2003

(54) Optical receiver for receiving a plurality of input signals

(76) Inventors: Jyh-Ming Jong, Saratoga, CA (US); Drew G. Doblar, San Jose, CA (US); Daniel R. Cassiday, Topsfield, MA (US)

Correspondence Address: HOYT A. FLEMING III, P.O. BOX 140678, BOISE, ID, 83714, US

(21) Appl. No.: 09/929,150

(22) Filed: Aug. 13, 2001

(51) Int. Cl. H04B 10/00; H04B 10/06

(52) U.S. Cl. 359/189; 359/158

(57) ABSTRACT

An optical receiver for receiving a first input data signal and a second input data signal, the optical receiver comprising: a first photo-detector, the first photo-detector operable to receive the first input data signal and operable to output a first electrical signal; a second photo-detector, the second photo-detector operable to receive the second input data signal and operable to output a second electrical signal; a phase-locked-loop, the phase-locked-loop operable to receive a reference clock signal; a clock-recovery circuit, the clock-recovery circuit coupled to the phase-locked-loop, the clock-recovery circuit operable to receive the first electrical signal; a latch-decision circuit, the latch-decision circuit coupled to the clock-recovery circuit; and a latch, the latch coupled to the latch-decision circuit, the latch operable to receive the first electrical signal and the second electrical signal.

This patent application discloses subject matter that is related to the subject matter disclosed in U.S. patent application Ser. No. ______ entitled “Optical Transmitter for Transmitting a Plurality of Output Signals” filed on even date herein.

### 1. FIELD OF THE INVENTION

The present invention generally relates to optical receivers. More specifically, the present invention relates to optical receivers that include multiple photo-detectors.

### 2. BACKGROUND

Some modem communication systems, such as InfiniBand systems, require high-speed optical signals to be converted into high-speed electrical signals. Because optical functionality is relatively expensive when compared to electronic functionality, the overall system costs can generally be minimized by using optical components, such as photo-detectors and fiber optic cables, which are as low performance as can be tolerated. Such communication systems utilize signal-conditioning circuits in the electrical domain to reduce jitter from the electrical signals that are converted from optical signals. FIG. 1 presents a prior art optical receiver 100.

The optical receiver 100 includes a photo-detector 135, such as a photodiode. The photo-detector 135 converts the input data signal from an optical signal into an electrical signal 115.

The optical receiver 100 also includes a phase-locked-loop 105. The phase-locked-loop 105 receives a reference clock signal 110 and generates a plurality of clock signals. Each of the plurality of clock signals has a frequency that is approximately equal to the frequency of the electrical signal 115. However, the phase of each of the clock signals differ. For example, each clock signal may have a phase that differs by a predetermined multiple, such as π/6 radians, from its phase-adjacent clock signal. In this way, an entire cycle (2π radians) of the clock signal can be covered by evenly spaced (in terms of phase) clock signals.

The optical receiver 100 also includes a clock-recovery circuit 120. The clock-recovery circuit 120 is coupled to the phase-locked-loop 105. In addition, the clock-recovery circuit 120 is operable to receive the electrical signal 115. As is known in the art, the clock-recovery circuit 120 is operable to extract timing information from the electrical signal 115.

The optical receiver 100 also includes a latch-decision circuit 125. The latch-decision circuit 125 is coupled to the clock-recovery circuit 120. The latch-decision circuit 125 may also be operable to receive the electrical signal 115. The latch-decision circuit 125 is operable to determine, using algorithms known in the art, an appropriate time to latch the electrical signal 115 so that the electrical signal 115 is sampled near the center portion of each pulse that corresponds to either logic “1” or logic “0.” Such a determination is based upon the timing information that is received from the clock-recovery circuit 120 and information extracted from the electrical signal 115.

The optical receiver 100 also includes a latch 130. The strobe input of the latch 130 is coupled to the latch-decision circuit 125. The data input of the latch 130 is operable to receive the electrical signal 115. The output of the latch 130, the output data signal, can be utilized by the communication system as is known by those of skill in the art.

The phase-locked-loop 105, the clock-recovery circuit 120, the latch-decision circuit 125, and the latch 130 work together to minimize the jitter in electrical signal 115. Thus, a low performance photo-detector 135 can be utilized to reduce the cost of the optical receiver 100.

In order to increase the bandwidth of InfiniBand links, the InfiniBand specification provides for optical receivers that include multiple photo-detectors. For example, one InfiniBand link, which is known as a 4X link, includes 4 photo-detectors. Another InfiniBand link, which is known as a 12X link, includes 12 photo-detectors.

FIG. 2 presents a portion of a prior art optical receiver 200 that includes multiple photo-detectors 235 and 265. The first photo-detector 235 converts the first input data signal from an optical signal into a first electrical signal 215. Similarly, the second photo-detector 265 converts the second input data signal from an optical signal into a second electrical signal 245.

The optical receiver 200 also includes a first phase-locked-loop 205 and a first clock-recovery circuit 220. The first clock-recovery circuit 220 is coupled to the first phase-locked-loop 205 and is operable to receive the first electrical signal 215. The optical receiver 200 also includes a first latch-decision circuit 225 that is coupled to the first clock-recovery circuit 220 and may also be operable to receive the first electrical signal 215. The optical receiver 200 also includes a first latch 230 that is coupled to the first latch-decision circuit 225 and is operable to receive the first electrical signal 215.

As shown in FIG. 2, the optical receiver 200 also includes a second photodetector 265, a second phase-locked-loop 240, a second clock-recovery circuit 250, a second latch-decision circuit 255, and a second latch 260.

The first phase-locked-loop 205, the first clock-recovery circuit 220, the first latch-decision circuit 225, and the first latch 230 work together to minimize the jitter in the first electrical signal 215. Similarly, the second phase-locked-loop 240, the second clock-recovery circuit 250, the second latch-decision circuit 255, and the second latch 260 work together to minimize the jitter in the second electrical signal 245. Thus, low performance photo-detectors 235 and 265 can be utilized to reduce the cost of the optical receiver 200.

While the optical receiver 200 can generate high quality optical signals that are compliant with the InfiniBand specification, the cost of such a receiver is significant. Thus, a need exists for a cost-reduced optical receiver that utilizes a reduced die-size and uses lower power than the prior art, and that is operable to receive high-speed optical input signals.

### 3. SUMMARY OF INVENTION

One embodiment of the invention is an optical receiver for receiving a first input data signal and a second input data signal. The optical receiver includes: a first photodetector, the first photo-detector operable to receive the first input data signal and operable to output a first electrical signal; a phase-locked-loop, the phase-locked-loop operable to receive a reference clock signal; a clock-recovery circuit, the clock-recovery circuit coupled to the phase-locked-loop, the clock-recovery circuit operable to receive the first electrical signal; a first latch-decision circuit, the first latch-decision circuit coupled to the clock-recovery circuit; a first latch, the first latch coupled to the first latch-decision circuit, the first latch operable to receive the first electrical signal; a second photo-detector, the second photo-detector operable to receive the second input data signal and operable to output a second electrical signal; a second latch-decision circuit, the second latch-decision circuit coupled to the clock-recovery circuit; and a second latch, the second latch coupled to the second latch-decision circuit, the second latch operable to receive the second electrical signal.

Another embodiment is an optical receiver for receiving a first input data signal and a second input data signal. This optical receiver includes: a first photo-detector, the first photo-detector operable to receive the first input data signal and operable to output a first electrical signal; a phase-locked-loop, the phase-locked-loop operable to receive a reference clock signal; a clock-recovery circuit, the clock-recovery circuit coupled to the phase-locked-loop, the clock-recovery circuit operable to receive the first electrical signal; a latch-decision circuit, the latch-decision circuit coupled to the clock-recovery circuit; a first latch, the first latch coupled to the latch-decision circuit, the first latch operable to receive the first electrical signal; a second photo-detector, the second photodetector operable to receive the second input data signal and operable to output a second electrical signal; and a second latch, the second latch coupled to the latch-decision circuit, the second latch operable to receive the second electrical signal.

Still another embodiment of the invention is yet another optical receiver for receiving a first input data signal and a second input data signal. The optical receiver includes: a first photo-detector, the first photo-detector operable to receive the first input data signal and operable to output a first electrical signal; a second photo-detector, the second photo-detector operable to receive the second input data signal and operable to output a second electrical signal; a phase-locked-loop, the phase-locked-loop operable to receive a reference clock signal; a clock-recovery circuit, the clock-recovery circuit coupled to the phase-locked-loop, the clock-recovery circuit operable to receive the first electrical signal; a latch-decision circuit, the latch-decision circuit coupled to the clock-recovery circuit; and a latch, the latch coupled to the latch-decision circuit, the latch operable to receive the first electrical signal and the second electrical signal.

### 4. BRIEF DESCRIPTION OF THE FIGURES

FIG. 1 presents a prior art optical receiver.

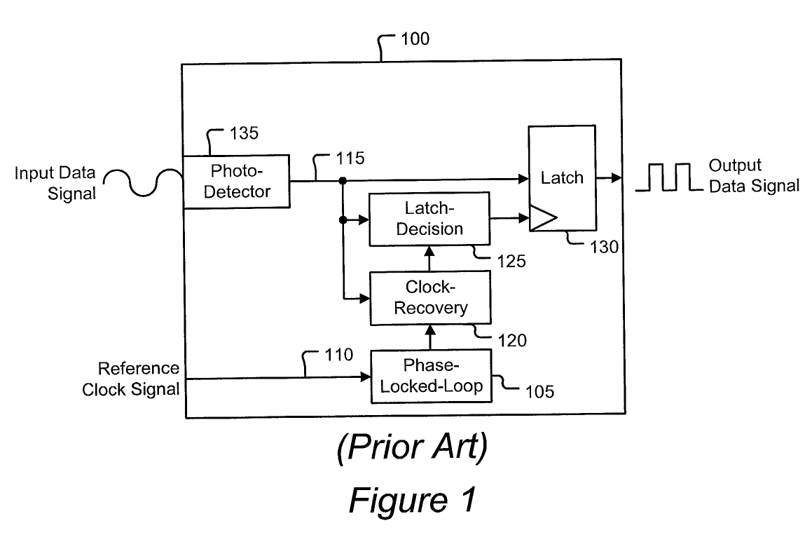

FIG. 2 presents a prior art optical receiver that includes multiple photodetectors.

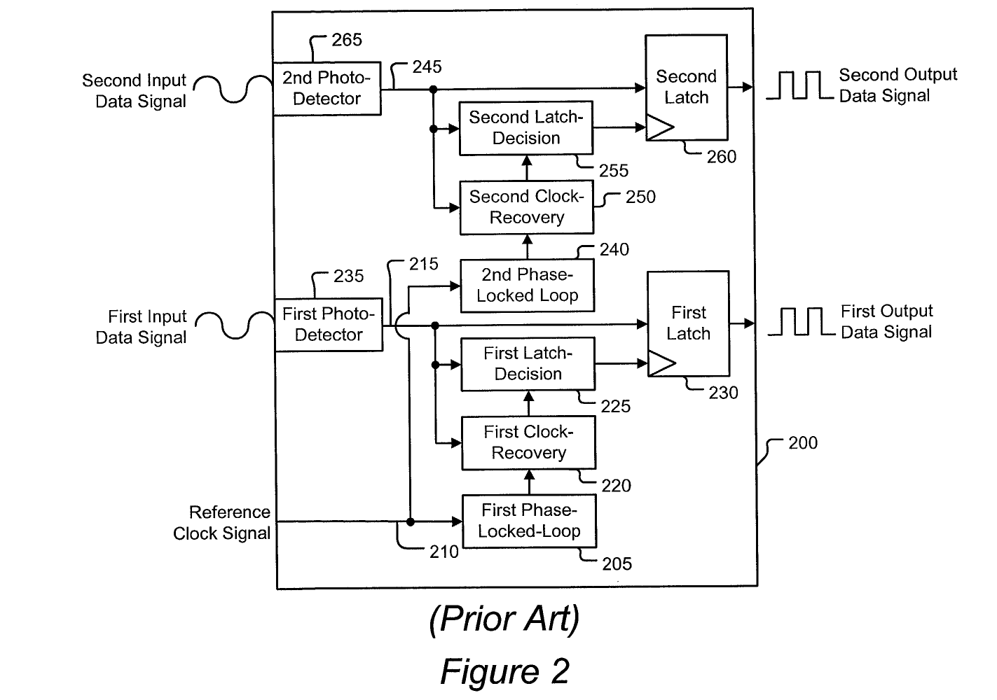

FIG. 3 presents an improved optical receiver that includes a single clock-recovery circuit.

FIG. 4 presents an improved optical receiver that includes a single latch-decision circuit.

FIG. 5 presents an improved optical receiver that includes a single multiple-channel latch.

### 5. DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

5.1 An Optical Receiver with a Single Clock-Recovery Circuit

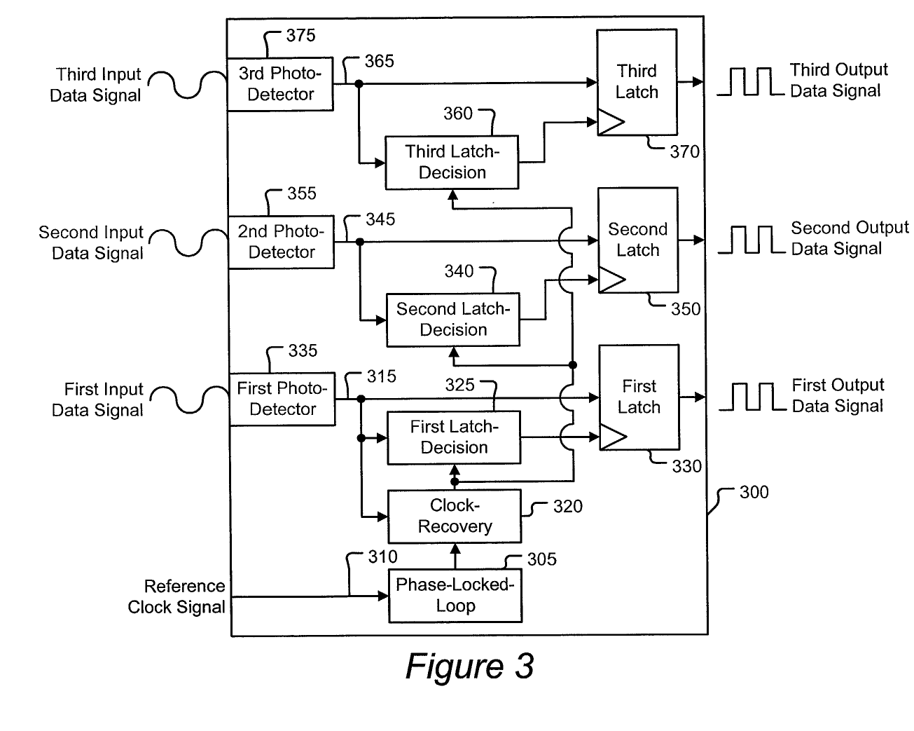

FIG. 3 presents an optical receiver 300. As will be discussed below, the optical receiver 300 can be manufactured at a lower cost than prior art optical receivers with multiple photo-detectors.

The optical receiver 300 includes a plurality of photo-detectors 335, 355, and 375. The first photo-detector 335 is operable to convert the first input data signal from an optical signal into a first electrical signal 315. Similarly, the second photo-detector 355 is operable to convert the second input data signal into a second electrical signal 345 and the third photo-detector 375 is operable to convert the third input data signal into a third electrical signal 365. In some embodiments of the invention, the photo-detectors 335, 355, and 375 include a photo-diode and may be operable to receive optical signals that are compliant with the optical signals defined in the InfiniBand specification.

The optical receiver 300 also includes a phase-locked-loop 305 that receives a reference clock signal 310 and generates a plurality of clock signals. Each of the plurality of clock signals has a frequency that is approximately equal to the frequency of the first electrical signal 315. However, each of the clock signals has a phase that differs by a predetermined multiple, such as π/4, π/6, π/8, or π/16 radians, from its phase-adjacent clock signal. Thus, at least one of the plurality of clock signals will have a phase that is not equal to the phase of the reference clock signal 315.

The optical receiver 300 also includes a clock-recovery circuit 320. The clock-recovery circuit 320 is coupled to the phase-locked-loop 305. In addition, the clock-recovery circuit 320 is operable to receive a first electrical signal 315. Using techniques that are known in the art, the clock-recovery circuit 320 is operable to extract timing information from the first electrical signal 315.

The optical receiver 300 also includes a first latch-decision circuit 325. The first latch-decision circuit 325 is coupled to the clock-recovery circuit 320. In addition, in some embodiments of the invention, the first latch-decision circuit 325 may also be operable to receive the first electrical signal 315. Using algorithms that are known in the art, the first latch-decision circuit 325 is operable to determine an appropriate time to latch the first electrical signal 315 so that the first electrical signal 315 is sampled near the center portion of each pulse that corresponds to either logic “1” or logic “0.” Such a determination is based upon the timing information that is received from the clock-recovery circuit 320 and, optionally, information extracted from the first electrical signal 315.

Referring again to FIG. 3, the optical receiver 300 also includes a first latch 330. The strobe input of the first latch 330 is coupled to the first latch-decision circuit 325. The data input of the first latch 330 is operable to receive the first electrical signal 315.

The optical receiver 300 also includes a second latch-decision circuit 340. The second latch-decision circuit 340 is coupled to the clock-recovery circuit 320. In addition, in some embodiments of the invention, the second latch-decision circuit 340 may also be operable to receive the second electrical signal 345. The second latch-decision circuit 340 is operable to determine an appropriate time to latch the second electrical signal 345 so that the second electrical signal 345 is sampled near the center portion of each pulse that corresponds to either logic “1” or logic “0.” Such a determination is based upon the timing information that is received from the clock-recovery circuit 320 and, optionally, information extracted from the second electrical signal 345.

Referring again to FIG. 3, the optical receiver 300 also includes a second latch 350. The strobe input of the second latch 350 is coupled to the second latch-decision circuit 340. The data input of the second latch 350 is operable to receive the second electrical signal 345.

In some embodiments of the invention, additional latch-decision circuits, latches, and photo-detectors may be present. For example, the optical receiver 300 includes a third latch-decision circuit 360 that is coupled to the clock-recovery circuit 320 and is operable to receive the third electrical signal 365. The optical receiver 300 includes a third latch 370 that is coupled to the third latch-decision circuitry 360 and is operable to receive the third electrical signal 365.

In still other embodiments of the invention, the optical receiver may include 4, 8 or 12 photo-detectors, latch-decision circuits, and latches.

As is evident from FIG. 3, the optical receiver 300 utilizes a single phase-locked-loop 305 and a single clock-recovery circuit 320 to provide information to a plurality of latch-decision circuits 325, 340, and 360. These latch-decision circuits 325, 340, and 360 control a plurality of latches 330, 350, and 370 that latch electrical signals 315, 345, and 365 that are output from a plurality of photo-detectors 335, 355, and 375.

By eliminating multiple instances of clock-recovery circuits, the die size of the optical receiver 300 can be reduced. As a result, the cost of manufacturing the optical receiver 300 is less than the cost of manufacturing prior art optical receivers that include multiple photo-detectors.

5.2 An Optical Receiver with a Single Latch-Decision Circuit

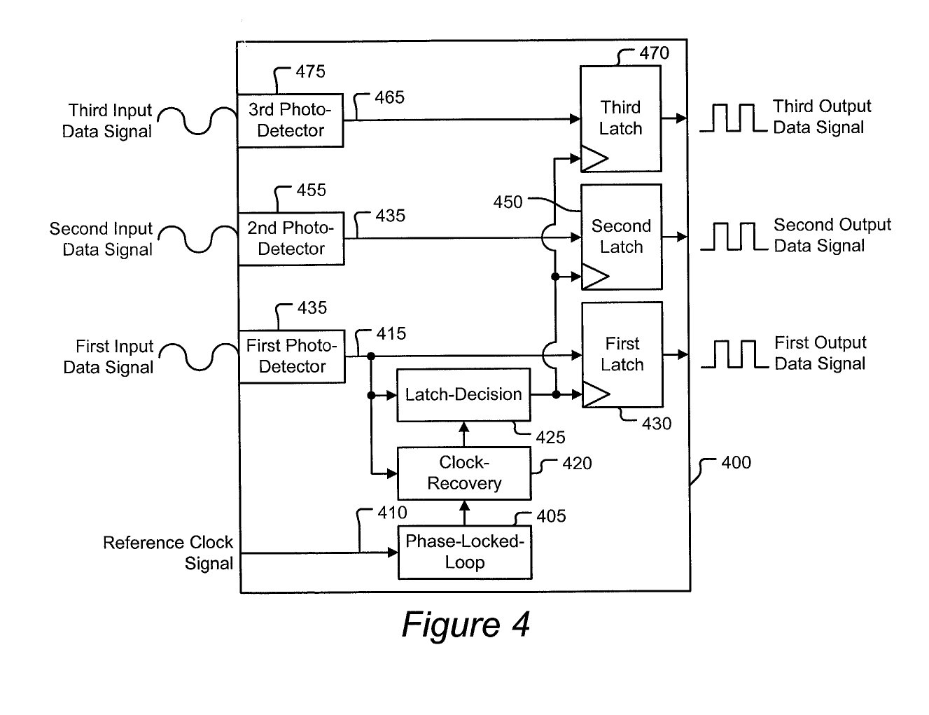

FIG. 4 presents another cost-reduced optical receiver 400 that includes a plurality of photo-detectors 435, 455, and 475 that output a plurality of electrical signals 415, 435, and 465. The optical receiver 400 also includes a phase-locked-loop 405 that is operable to receive a reference clock signal 410. The phase-locked-loop 405 is similar to the phase-locked-loop 305 described above. The optical receiver 400 also includes a clock-recovery circuit 420 that is coupled to the phase-locked-loop 405 and is operable to receive the first electrical signal 415. The optical receiver 400 also includes a latch-decision circuit 425. The latch-decision circuit 425 is similar to latch-decision circuit 325. However, latch-decision circuit 425 is coupled to a plurality of latches 430, 450, and 470.

As is evident from FIG. 4, the optical receiver 400 utilizes a single phase-locked-loop 405, a single clock-recovery circuit 420, and a single latch-decision circuit 425, to control a plurality of latches 430, 450, and 470 that are operable to receive a plurality of electrical signals 415, 435, and 465.

By eliminating multiple instances of clock-recovery circuits and latch-decision circuits, the die size of the optical receiver 400 can be reduced. As a result, the cost of manufacturing the optical receiver 400 is less than the cost of manufacturing prior art optical receivers that include multiple photo-detectors.

5.3 An Optical Receiver with a Single Multiple-Channel Latch

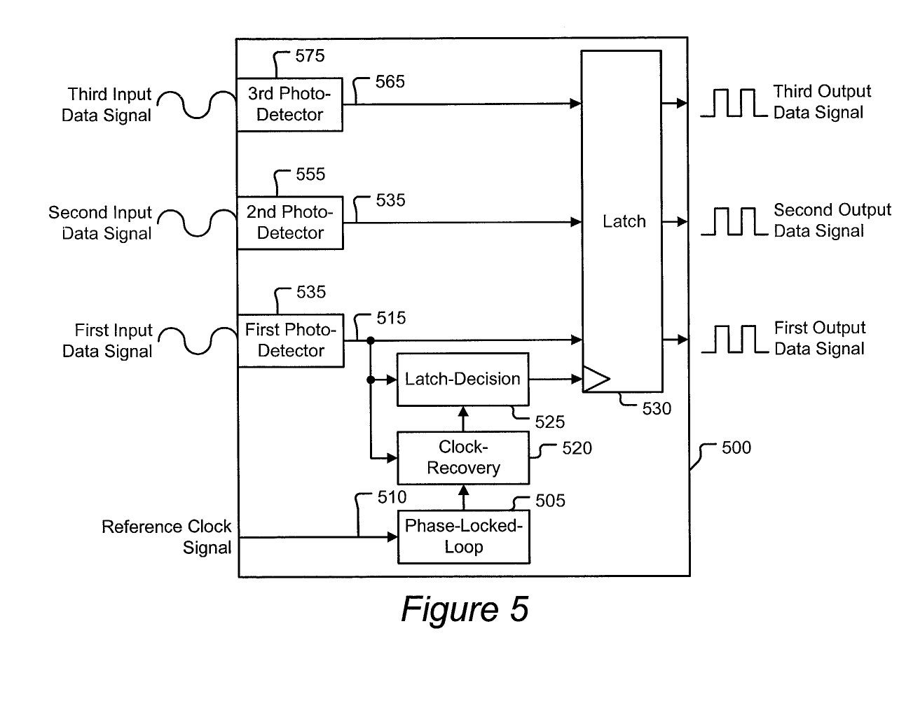

Another embodiment of the invention is shown in FIG. 5. FIG. 5 presents an optical receiver 500 that is very similar to the optical receiver 400 with the exception that the optical receiver 500 only includes a single latch 530. However, the latch 530 is operable to latch multiple electrical signals 515, 535, and 565. Referring to FIG. 5, the strobe input of the latch 530 is coupled to the latch-decision circuit 525.

By replacing multiple latches with a single latch that is operable to latch multiple electrical signals, the die size of the optical receiver 500 can be further reduced. Thus, the cost of manufacturing the optical receiver 500 is less than the cost of manufacturing prior art optical receivers that include multiple photo-detectors.

5.4 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. An optical receiver for receiving a first input data signal and a second input data signal, the optical receiver comprising:
a) a first photo-detector, the first photo-detector operable to receive the first input data signal and operable to output a first electrical signal;
b) a phase-locked-loop, the phase-locked-loop operable to receive a reference clock signal;
c) a clock-recovery circuit, the clock-recovery circuit coupled to the phase-locked-loop, the clock-recovery circuit operable to receive the first electrical signal;
d) a first latch-decision circuit, the first latch-decision circuit coupled to the clock-recovery circuit;
e) a first latch, the first latch coupled to the first latch-decision circuit, the first latch operable to receive the first electrical signal;
f) a second photo-detector, the second photo-detector operable to receive the second input data signal and operable to output a second electrical signal;
g) a second latch-decision circuit, the second latch-decision circuit coupled to the clock-recovery circuit; and
h) a second latch, the second latch coupled to the second latch-decision circuit, the second latch operable to receive the second electrical signal.

2. The optical receiver for receiving the first input data signal and the second input data signal of claim 1, wherein the phase-locked-loop is operable to generate a plurality of clock signals that have a frequency higher than the frequency of the reference clock signal.

3. The optical receiver for receiving the first input data signal and the second input data signal of claim 1, wherein the phase-locked-loop is operable to generate a plurality of clock signals that have a frequency higher than the frequency of the reference clock signal and wherein at least one of the plurality of clock signals has a phase that is not equal to the phase of the reference clock signal.

4. The optical receiver for receiving the first input data signal and the second input data signal of claim 1, wherein the clock-recovery circuit is operable to extract timing information from the first electrical signal.

5. The optical receiver for receiving the first input data signal and the second input data signal of claim 1, wherein the first latch-decision circuit, based upon timing information received from the clock-recovery circuit, is operable to determine a time to latch the first electrical signal.

6. The optical receiver for receiving the first input data signal and the second input data signal of claim 1, wherein the first latch-decision circuit is operable to receive the first electrical signal.

7. The optical receiver for receiving the first input data signal and the second input data signal of claim 1, wherein the first latch-decision circuit is operable to receive the first electrical signal and the second latch-decision circuit is operable to receive the second electrical signal.

8. The optical receiver for receiving the first input data signal and the second input data signal of claim 1, wherein the first latch-decision circuit is operable to receive the first electrical signal and, based upon information extracted from the first electrical signal and timing information received from the clock-recovery circuit, is operable to determine a time to latch the first input signal.

9. The optical receiver for receiving the first input data signal and the second input data signal of claim 1, wherein the first photo-detector includes a photo-diode.

10. The optical receiver for receiving the first input data signal and the second input data signal of claim 1, wherein the first photo-detector is operable to receive an optical signal that is compliant with an optical signal defined in the InfiniBand specification.

11. An optical receiver for receiving a first input data signal and a second input data signal, the optical receiver comprising:
a) a first photo-detector, the first photo-detector operable to receive the first input data signal and operable to output a first electrical signal;
b) a phase-locked-loop, the phase-locked-loop operable to receive a reference clock signal;
c) a clock-recovery circuit, the clock-recovery circuit coupled to the phase-lockedloop, the clock-recovery circuit operable to receive the first electrical signal;
d) a latch-decision circuit, the latch-decision circuit coupled to the clock-recovery circuit;
e) a first latch, the first latch coupled to the latch-decision circuit, the first latch operable to receive the first electrical signal;
f) a second photo-detector, the second photo-detector operable to receive the second input data signal and operable to output a second electrical signal; and
g) a second latch, the second latch coupled to the latch-decision circuit, the second latch operable to receive the second electrical signal.

12. The optical receiver for receiving the first input data signal and the second input data signal of claim 11, wherein the phase-locked-loop is operable to generate a plurality of clock signals that have a frequency higher than the frequency of the reference clock signal.

13. The optical receiver for receiving the first input data signal and the second input data signal of claim 11, wherein the phase-locked-loop is operable to generate a plurality of clock signals that have a frequency higher than the frequency of the reference clock signal and wherein at least one of the plurality of clock signals has a phase that is not equal to the phase of the reference clock signal.

14. The optical receiver for receiving the first input data signal and the second input data signal of claim 11, wherein the clock-recovery circuit is operable to extract timing information from the first electrical signal.

15. The optical receiver for receiving the first input data signal and the second input data signal of claim 11, wherein the latch-decision circuit, based upon timing information received from the clock-recovery circuit, is operable to determine a time to latch the first input signal and the second input signal.

16. The optical receiver for receiving the first input data signal and the second input data signal of claim 11, wherein the latch-decision circuit is operable to receive the first electrical signal.

17. The optical receiver for receiving the first input data signal and the second input data signal of claim 11, wherein the first latch-decision circuit is operable to receive the first electrical signal and, based upon information extracted from the first electrical signal and timing information received from the clock-recovery circuit, is operable to determine a time to latch the first input signal.

18. The optical receiver for receiving the first input data signal and the second input data signal of claim 11, wherein the first photo-detector includes a photo-diode.

19. The optical receiver for receiving the first input data signal and the second input data signal of claim 11, wherein the first photo-detector is operable to receive an optical signal that is compliant with an optical signal defined in the InfiniBand specification.

20. An optical receiver for receiving a first input data signal and a second input data signal, the optical receiver comprising:
a) a first photo-detector, the first photo-detector operable to receive the first input data signal and operable to output a first electrical signal;
b) a second photo-detector, the second photo-detector operable to receive the second input data signal and operable to output a second electrical signal;
c) a phase-locked-loop, the phase-locked-loop operable to receive a reference clock signal;
d) a clock-recovery circuit, the clock-recovery circuit coupled to the phase-locked-loop, the clock-recovery circuit operable to receive the first electrical signal;
e) a latch-decision circuit, the latch-decision circuit coupled to the clock-recovery circuit; and
f) a latch, the latch coupled to the latch-decision circuit, the latch operable to receive the first electrical signal and the second electrical signal.

21. The optical receiver for receiving the first input data signal and the second input data signal of claim 20, wherein the phase-locked-loop is operable to generate a plurality of clock signals that have a frequency higher than the frequency of the reference clock signal.

22. The optical receiver for receiving the first input data signal and the second input data signal of claim 20, wherein the phase-locked-loop is operable to generate a plurality of clock signals that have a frequency higher than the frequency of the reference clock signal and wherein at least one of the plurality of clock signals has a phase that is not equal to the phase of the reference clock signal.

23. The optical receiver for receiving the first input data signal and the second input data signal of claim 20, wherein the clock-recovery circuit is operable to extract timing information from the first electrical signal.

24. The optical receiver for receiving the first input data signal and the second input data signal of claim 20, wherein the latch-decision circuit, based upon timing information received from the clock-recovery circuit, is operable to determine a time to latch the first input signal and the second input signal.

25. The optical receiver for receiving the first input data signal and the second input data signal of claim 20, wherein the latch-decision circuit is operable to receive the first electrical signal.

26. The optical receiver for receiving the first input data signal and the second input data signal of claim 20, wherein the first latch-decision circuit is operable to receive the first electrical signal and, based upon information extracted from the first electrical signal and timing information received from the clock-recovery circuit, is operable to determine a time to latch the first input signal.

27. The optical receiver for receiving the first input data signal and the second input data signal of claim 20, wherein the first photo-detector includes a photo-diode.

28. The optical receiver for receiving the first input data signal and the second input data signal of claim 20, wherein the first photo-detector is operable to receive an optical signal that is compliant with an optical signal defined in the InfiniBand specification.
